(19) United States
(12) Patent Application Publication
(10) Pub. No.: US 2013/0052560 A1
(43) Pub. Date: Feb. 28, 2013

(54) MEMBRANE-ELECTRODE-ASSEMBLY AND FUEL CELL

(71) Applicants: Jun Kawaji, Hitachinaka (JP); Shuichi Suzuki, Hitachinaka (JP); Takaaki Mizukami, Hitachi (JP); Yoshiyuki Takamori, Hitachinaka (JP)

(72) Inventors: Jun Kawaji, Hitachinaka (JP); Shuichi Suzuki, Hitachinaka (JP); Takaaki Mizukami, Hitachi (JP); Yoshiyuki Takamori, Hitachinaka (JP)

(73) Assignee: HITACHI, LTD., Tokyo (JP)

(21) Appl. No.: 13/571,688

(22) Filed: Aug. 10, 2012

(30) Foreign Application Priority Data
Aug. 31, 2011 (JP) 2011188162

(51) Int. Cl. H01M 8/10; H01M 4/88

(52) U.S. Cl. 429/482; 502/101

(57) ABSTRACT

A membrane-electrode-assembly contains two or more types of solid polymer electrolytes having different acid dissociation constants in an electrode catalyst layer, a solid polymer electrolyte of small acid strength covers the surface of a catalyst, and a solid polymer electrolyte of large acid strength is disposed to the periphery thereof, which makes the resistance to dissolving of the catalyst metal and the ion conductivity in the catalyst electrode layer compatible.

### FIELD OF THE INVENTION

The present invention concerns a fuel cell and it particularly relates to a membrane-electrode-assembly having a catalyst electrode layer coated on an electrolyte membrane.

### BACKGROUND OF THE INVENTION

A fuel cell is a device for converting a chemical energy directly into an electric energy.

A reducing material such as hydrogen, methanol, or hydrazine as a fuel and an oxidizing gas such as air or oxygen as an oxidizing agent are supplied respectively to a fuel electrode (anode) and an air electrode (cathode). Then, electrons formed by oxidation/reduction reaction that proceeds on a catalyst contained in the electrode layer are taken out and used as the electric energy.

Fuel cells can be classified into a solid polymer type, a phosphate type, a molten carbonate type and a solid oxide type depending on the material of the electrolyte membrane, operation temperature, etc.

Among them, a polymer electrolyte fuel cell (PEFC) of using a solid polymer electrolyte membrane that has proton conductivity typically represented by a perfluoro sulfonic acid resin, sulfonated aromatic hydrocarbon resin, etc. and generates electric power by oxidation of hydrogen on the side of an anode and reduction of oxygen on the side of a cathode has been known as a battery capable of power generation at a relatively low temperature and having high power density.

Further, a direct methanol fuel cell (DMFC) using methanol or aqueous solution of methanol as a liquid instead of hydrogen as a fuel also has attracted attention in recent years. DMFC is classified, for example, into an active type (fuel and air are supplied compulsorily), a semi-active type (one of fuel and air is supplied compulsorily), or a passive type (fuel and air are supplied spontaneously) depending on the method of supplying fuel and air.

Electric power is generated in PEFC and DMFC by a membrane-electrode-assembly (MEA) of a configuration of sandwiching a solid polymer electrolyte membrane between an anode and a cathode. In the catalyst electrode layers of the anode and the cathode, a catalyst metal, an electron conductor on which the catalyst metal is supported, and a polymer resin having proton conductivity (proton conductive resin) are present in admixture.

The proton conductive resin is also referred to as an ionomer or a binder and has a role, for example, of binding electronic conductors to each other, efficiently transferring protons reacted on the catalyst metal to the electrolyte membrane.

Since the polymer having sulfonate groups described above is used as an electrolyte membrane having protonic conductivity used in PEFC or DMFC, the perfluoro alkyl sulfonic acid polymer is used in the same manner also for the proton conductive resin in the catalyst electrode layer.

As a catalyst metal used for the membrane-electrode-assembly, fine particles of a Pt alloy are generally used. This is because they show high catalytic activity in a state covered with a binder containing a sulfonic acid having an acid dissociation constant (pKa) of 1 or less, that is, under a strongly acid condition, and is excellent in the resistance to dissolving also under the acid condition.

In recent years, research has been made for the catalyst using a metal material less expensive than Pt, but the material is limited to noble metals with a viewpoint of high resistance to dissolving under the strongly acid condition. Since noble metals including Pt are restricted in view of resource reserve, this involves a subject in popularized use.

By the way, fuel cells using polymers containing functional groups other than sulfonate groups have been proposed in recent years.

In Japanese Unexamined Patent Application Publications Nos. 2007-280740 and 2006-236986, etc., polymers having phosphate groups or carboxylic groups are used as a binder having a proton exchange groups other than sulfonate groups.

Further, an anion-exchange membrane fuel cell (AMFC) of using an electrolyte having quaternary amine groups, for example, trimethylamine groups to render the inside of the fuel cell into an alkaline atmosphere and utilizing hydroxide ions (OH⁻) as a carrier has attracted attention.

In AMFC, since the inside of the catalyst electrode layer is a basic atmosphere, it can be expected that a sufficient resistance to dissolving is kept also by using transition metals such as nickel, iron, cobalt, etc. Further, since there are many catalyst materials showing higher activity in a basic atmosphere than in an acidic atmosphere, AMFC is expected as a fuel cell reduced in the cost and having high efficiency.

However, the proton exchange resin having phosphate groups, carboxylic groups, etc. and the anion-exchange resin used in AMFC generally show low ion conductivity compared with resins having sulfonate groups and, accordingly, this causes increase of the internal resistance in the fuel cell.

Particularly, the anion-exchange resin tends to absorb carbon dioxide present in the air and, as a result, carbonate ions are present in the anion-exchange resin, which is a main factor for further lowering the ion conductivity.

Japanese Unexamined Patent Application Publication No. 2010-182589 proposes a fuel cell system of a configuration of electrolyzing water by using an external power source and introducing generated OH⁻ ions into the membrane for periodically removing carbonate ions in the electrolyte membrane in AMFC.

Further, a hybrid type fuel cell of using an anion-exchange resin for the binder in a catalyst electrode layer and a proton exchange resin, for example, a perfluoroalkyl sulfonic acid polymer for the electrolyte membrane has been proposed in recent years. This intends to improve the catalytic activity by rendering the atmosphere in the catalyst electrode layer basic and lower the membrane resistance by using the proton exchange resin (the Journal of Physical Chemistry C, 113, 11416 (2009))

### SUMMARY OF THE INVENTION

In the means for removing the carbonate ions proposed in JP-A No. 2010-182589, since the efficiency of the fuel cell is lowered by so much as the OH⁻ generation device, it is desirable not to use such an auxiliary device as much as possible.

Further, in the hybrid type fuel cell disclosed in the Journal of Physical Chemistry C, 113, 11416 (2009), since the interface between the proton exchange resin and the anionic resin is present between the electrolyte membrane and the electrode and the interface resistance may possibly increase the internal resistance. Further, since the inside of the catalyst electrode layer is entirely composed of the anion-exchange resin, there may be a concern that the ion conduction resistance in the catalyst electrode layer may also increase.

As described above, it is difficult in the existent membrane-electrode-assembly to further lower the internal resistance of the entire membrane-electrode-assembly while increasing the resistance to dissolving of the catalyst metal.

The present invention intends to provide a membrane-electrode-assembly for a fuel cell capable of improving the resistance to dissolving of a catalyst metal and lowering the internal resistance of a membrane-electrode-assembly together, as well as a manufacturing method thereof.

In a membrane-electrode-assembly for a fuel cell according the present invention, an anode including a catalyst electrode layer containing catalyst particles and a solid polymer electrolyte having ion exchange groups and a cathode including a catalyst electrode layer containing catalyst particles and a solid polymer electrolyte having ion exchange groups are formed with a solid polymer electrolyte membrane put between them, in which a catalyst electrode layer of at least one of the anode and the cathode contains a first solid polymer electrolyte having ion exchange groups and a second solid polymer electrolyte having ion exchange groups different from those of the first solid polymer electrolyte, and acid dissociation constants (pKa) of the ion exchange groups of the solid polymer electrolytes are different.

According to the invention, since the resistance to dissolving of the catalyst metal in the anode and the cathode is improved and, further, a membrane-electrode-assembly of low internal resistance is obtained, a membrane-electrode-assembly for a fuel cell having long life and high efficiency can be provided.

Further, an electrochemically less noble metal can be used for the catalyst used in the anode and the cathode, and cost in the membrane-electrode-assembly can be decreased.

### BRIEF DESCRIPTION OF THE DRAWINGS

FIG. 1 is a schematic cross sectional view of a fuel cell to be described in a preferred embodiment;

FIG. 2 is a schematic cross sectional view of carbon black particles supporting a catalyst metal thereon;

FIG. 3 is a schematic view inside of an existent electrode catalyst layer;

FIG. 4 is a schematic cross sectional view of a membrane-electrode-assembly according to a preferred embodiment;

FIG. 5 is a schematic cross sectional view of a membrane-electrode-assembly according to another preferred embodiment;

FIG. 6 is a schematic cross sectional view of a membrane-electrode-assembly according to a further preferred embodiment;

FIG. 7 is a schematic cross sectional view of a membrane-electrode-assembly according to a further preferred embodiment; and

FIG. 8 is a schematic view of a mobile information terminal according to a further preferred embodiment.

### DETAILED DESCRIPTION OF THE PREFERRED EMBODIMENTS

The present inventors, et al. have made an earnest study and, as a result, have found that the foregoing subjects can be solved by introducing a binder for covering catalyst particles to enhance the durability and other binder for increasing the ion conductivity inside the catalyst electrode layer and controlling the arrangement and the distribution state of the binder.

In a membrane-electrode-assembly for a fuel cell as a preferred embodiment of the invention, an anode including a catalyst electrode layer containing catalyst particles and a solid polymer electrolyte having ion exchange groups, and a cathode including a catalyst electrode layer containing catalyst particles and a solid polymer electrolyte having ion exchange groups are formed with a solid polymer electrolyte membrane put between them, in which the catalyst electrode layer of at least one of the anode and the cathode contains a first solid polymer electrolyte having ion exchange groups and a second solid polymer electrolyte having ion exchange groups different from those of the first solid polymer electrolyte, and the acid dissociation constants (pKa) of the ion exchange groups of the solid polymer electrolyte are different. The acid dissociation constant referred to herein is one of indexes of representing the acid strength of a material and is represented as a negative common logarithm of an equilibrium constant Ka of an acid dissociating reaction. This means that a material of lower pKa value has stronger acidity. The acid dissociation constant of a solid polymer strongly undergoes the effect due to the type of the ion exchange group or the electron state of the polymer skeleton and can be estimated by calculation. When a polymer of high pKa is present in the catalyst electrode layer, the resistance to dissolving at the surface of the catalyst covered with the polymer is increased. On the other hand, since ions (mainly protons) transferring the inside of the catalyst electrode layer preferentially pass through the inside of the polymer of low pKa, the proton conductivity of the entire electrode can be increased.

Presence of two or more types of the solid polymer electrolyte in the catalyst electrode layer can be confirmed by separating a solid polymer leached from an electrode by chromatography and evaluating by liquid NMR, or evaluating by solid NMR. As a result, since the skeleton and the ion exchange groups of the solid polymer electrolyte can be revealed, the acid dissociation constant can be determined.

Further, in a membrane-electrode-assembly for a fuel cell as a preferred embodiment of the invention, the solid polymer electrolyte in the catalyst electrode layer includes a first solid polymer electrolyte covering the surface of catalyst particles and a second solid polymer electrolyte further covering the periphery thereof, in which the pKa of the first solid polymer electrolyte is higher than the pKa of the second solid polymer electrolyte. Since the first solid polymer electrolyte of higher pKa is in direct contact with the solid particles, and the second solid polymer electrolyte of lower pKa covers the periphery thereof, the resistance to dissolving of the catalyst is further increased preferably.

The state where the solid polymer electrolyte of higher pKa covers the surface of the catalyst in the catalyst electrode layer can be confirmed by the following method. At first, cross sectional polishing is performed to the electrode and layered distribution of the solid polymers of different elemental compositions on the surface of the catalyst particles is confirmed by observation under scanning electromicroscope, or observation of an element mapping image by EDX or EELS method to the cross sectional slice image of the electrode. Then, it can be confirmed that a solid polymer of high pKa preferentially covers the surface of the catalyst by identifying the chemical formula of the solid polymer electrolyte and with reference to the elemental composition distribution obtained by mapping in the same manner as described above.

Further, a membrane-electrode-assembly for a fuel cell as a preferred embodiment of the invention also includes those in which the second solid polymer electrolyte is in a particulate or acicular shape, catalyst particles covered with the first solid polymer electrolyte are arranged at the periphery of the second solid polymer electrolyte, and the pKa of the first solid polymer electrolyte is higher than the pKa of the second solid polymer electrolyte. That is, a second solid polymer agglomerated in the particulate or acicular shape is arranged between each of agglomerates including catalyst particles covered with the first solid polymer electrolyte. Such a configuration is also preferred since the second solid polymer electrolyte present in the particulate or acicular shape provides an ion conduction path and decreases the resistance of the entire electrode.

It is further preferred that when the grain size distribution of the electrolyte mass agglomerated in the particulate or acicular shape including the second solid polymer electrolyte has one or more peak and a relation: L1>40 nm where L1 represents a particle diameter giving the maximum peak is present, since the cross sectional area of the ion conduction path is sufficiently large to keep the resistance low and, further, voids are ensured between the catalyst particles covered with the first solid polymer electrolyte to transfer materials, such as fuel, oxidant and water, smoothly.

It is further preferred that when the grain size distribution of the agglomerated electrolyte mass including the second solid polymer electrolyte has one or more peaks and a relation: L1>40 nm where L1 represents a particle diameter providing the maximum peak is present, the cross sectional area of the ion conduction path is sufficiently large to keep the resistance low and the voids are ensured between the catalyst particles covered with the first solid polymer electrolyte to transfer materials, such as fuel, oxidant and water, smoothly.

Presence of the solid polymer electrolyte as the particulate or acicular mass in the catalyst electrode layer can be confirmed by observation of the cross section of the membrane-electrode-assembly under scanning electron microscope (SEM). When the second solid polymer electrolyte is in the particulate shape, L1 can be obtained by determining the area of the electrolyte mass in a cross sectional SEM image using an image analysis software and measuring the same as an equivalent circle diameter thereof on a histogram of equivalent circle diameter and frequency. An electrolyte mass this is referred to as an acicular electrolyte mass when the lengths of the mass along two axes crossing to each other are different and the ratio of the length is 2 or more. In this case, L1 can be determined by setting a major axis for each of the respective acicular masses, measuring the length thereof, and preparing a histogram of the length and the frequency.

Further, a membrane-electrode-assembly for a fuel cell as a preferred embodiment of the invention includes those in which catalyst particles covered with the first solid polymer electrolyte are arranged in voids of a three-dimensional network structure including a fibrous second solid polymer, and the pKa of the first solid polymer electrolyte is higher than the pKa of the second solid polymer electrolyte. The three-dimensional network structure including the fibrous second solid polymer means those where a plurality of fibers at an aspect ratio of 10 or more including a solid polymer electrolyte intersect each other and are bonded to each other at the contacts thereof. Since a large number of voids are present in the network structure described above and catalyst particles covered with the solid polymer electrolyte of high pKa are arranged therein, the resistance to dissolving of the catalyst particles can also be ensured and since the entire network structure provides an ion conduction path, the resistance is also lowered. The three-dimensional network structure is preferably formed by an electrospinning method since the ion conduction path becomes dense.

Further, a membrane-electrode-assembly for a fuel cell as a preferred embodiment of the invention also includes those in which catalyst particles include metal particles showing a catalytic effect and an electron conductor on which the metal particles are supported, and a relation: pKa>pH is established between the pKa of the first solid polymer electrolyte and the pH of an aqueous solution in which the solubility of the metal particle is 10⁻⁶ mol/L. pH is represented by a negative common logarithm of a hydrogen ion concentration in the aqueous solution. Use of the combination of the catalyst metal and the solid polymer electrolyte capable of establishing the relation is preferred since dissolution of the catalyst metal in the catalyst electrode layer can be kept as far as it can withstand the practical use in the fuel cell. The solubility of the metal particles can be determined by dipping the catalyst metal sufficiently in 1 L of an aqueous solution at various pH values as a concentration of dissolved metal ions. Alternatively, when the relation between the solubility of the metal constituting the catalyst and the temperature and the potential are described in data book, such data book can be referred to.

Further, a membrane-electrode-assembly for a fuel cell as a preferred embodiment of the invention also includes those in which the ion exchange groups contained in the first solid polymer are phosphate groups or carboxylic groups and, further, the ion exchange groups contained in the second solid polymer electrolyte are sulfonate groups in the membrane-electrode-assembly described above. In the configuration described above, the pKa of the first solid polymer electrolyte is higher than the pKa of the second solid polymer electrolyte and good resistance to dissolving and ion conductivity of the metal can be ensured.

Further, a membrane-electrode-assembly for a fuel cell as a preferred embodiment of the invention also includes those in which the first solid polymer electrolyte is an anion-exchange resin and the second solid polymer electrolyte is a proton exchange resin containing sulfonate groups in the membrane-electrode-assembly described above.

Further, the membrane-electrode-assembly described above also includes those in which the first solid polymer electrolyte is an anion-exchange resin containing ion exchange group of one of quaternary amine group and quarternary phosphine group, and the second solid polymer electrolyte is a proton exchange resin containing a sulfonate group. Also in the configuration described above, the pKa of the first solid polymer electrolyte is higher than the pKa of the second solid polymer electrolyte and good resistance to dissolving and ion conductivity of the metal can be ensured.

Since the interface between the anion-exchange resin and the proton exchange resin is present in the catalyst electrode layer, while the interfacial resistance is generated therebetween, this embodiment is preferred since the inside of the catalyst electrode layer includes a porous electrode and the total area of the interface extremely large, the effect thereof on the resistance for the entire membrane-electrode-assembly is small.

A membrane-electrode-assembly for a fuel cell in a preferred embodiment of the invention also includes those in which the first solid polymer electrolyte is a proton exchange resin where polyvalent basic materials are coordinated to the ion exchange groups in the membrane-electrode-assembly described above. The polyvalent basic material means a molecule containing two or more functional groups having an anion-exchange capacity such as an amine group. When such a molecule is mixed with the cation exchange resin, some of anion-exchange groups are ionically bonded with the proton exchange resin and the first solid polymer electrolyte shows an anion-exchange capacity due to the presence of the remaining anion-exchange groups. The foregoing effects can also be expected also in this case.

Further, a membrane-electrode-assembly for a fuel cell as a preferred embodiment of the invention also includes those in which the electrolyte membrane put between the electrodes described above is a proton exchange resin. A proton exchange resin having sulfonate groups is particularly preferred since the proton conduction resistance of the electrolyte membrane can be kept low.

Further, a membrane-electrode-assembly for a fuel cell as a preferred embodiment of the invention also includes those in which the chemical formula of the second solid polymer electrolyte and that of the electrolyte membrane are identical. This embodiment is preferred since the electrode and the electrolyte film are joined favorably to increase the stability.

Further, a membrane-electrode-assembly for a fuel cell as a preferred embodiment of the invention also includes those in which at least one of the first and second solid polymer electrolytes in the catalyst electrode layer and an electrolyte membrane put between the electrodes includes an aromatic hydrocarbon type electrolyte having sulfonate groups. This embodiment is preferred since the heat resistance of the electrode or the electrolyte membrane is excellent.

A membrane-electrode-assembly for a fuel cell as a preferred embodiment of the invention also includes those in which a metal material showing a catalytic effect contains at least one of palladium, nickel, iron, cobalt, and tungsten. This embodiment is preferred since a membrane-electrode-assembly can be manufactured at a reduced cost by using such a material for the catalyst metal compared with the electrode assembly using Pt for the catalyst.

A membrane-electrode-assembly for a fuel cell as a preferred embodiment of the invention in which the first solid polymer electrolyte covers the surface of the catalyst can be manufactured by way of the following steps: 1) a step of mixing catalyst particles and a first solid polymer electrolyte in a solvent to prepare a first paste; 2) a step of drying and pulverizing the paste thereby covering the surface of the catalyst particles with the first solid polymer electrolyte; 3) a step of mixing the catalyst particles covered with the first solid polymer electrolyte and a second solid polymer electrolyte in a solvent to prepare a second paste; and 4) a step of drying the second paste to form an electrode.

Further, when the first paste is prepared, a structure in which the first solid polymer stably covers the catalyst particles can be obtained by way of a step of adding a crosslinker to the paste, drying the paste and then proceeding the crosslinking reaction of the first solid polymer electrolyte by a heat treatment, since the first solid polymer electrolyte becomes insoluble in the second paste.

In the membrane-electrode-assembly for a fuel cell as a preferred embodiment of the invention, a structure in which the catalyst particles covered by the first solid polymer electrolyte are arranged in the voids of a three-dimensional network structure including the fibrous second solid polymer can be manufactured by way of the following steps: 1) a step of depositing a solution product of the second solid polymer electrolyte by using an electrospinning method thereby obtaining a porous thin film including the second solid polymer membrane; 2) a step of mixing the catalyst particles and the first solid electrolyte in a solvent to prepare a first paste; 3) a step of impregnating the first paste into the porous thin membrane, and drying them; and 4) a step of bonding them by thermocompression.

A fuel cell formed by using the membrane-electrode-assembly as the embodiment of the invention for a power generation section and using a gas diffusion layer, an air (oxygen) supplying member, and a current collector member can provide a high power fuel cell since appropriate proton conduction path and gas diffusion path are formed in a catalyst electrode layer. The fuel supplying member means a series of members that supply a fuel introduced by a pump or the like by way of a bipolar plate into a gas diffusion layer, and an air (oxygen) supplying member means a series of members that supply air (oxygen) introduced by a blower or the like into the diffusion layer by way of a bipolar plate. As the fuel, a hydrogen gas and an alcohol such as methanol or ethanol can be used.

Further, a nitrogen-containing compound such as hydrazine or ammonia can be used as the fuel.

The fuel is electrochemically oxidized on the anode and oxygen is reduced on the cathode to form an electric potential between both of the electrodes. When a load is applied as an external circuit between both of the electrodes, ion transfer occurs in the electrolyte, and electric energy is taken out to the external load. Accordingly, various types of fuel cells are highly expected for large-scale power generation systems, small-scale dispersion type cogeneration systems, power source systems for electric car, etc. and practical development therefore has been conducted vigorously.

As described above, the preferred embodiments of the invention can provide a structure of a membrane-electrode-assembly excellent in the durability of the catalyst and showing low electrode overvoltage by using a resin of a relatively high pKa as a solid polymer electrolyte that covers the surface of catalyst particles thereby suppressing the resistance to dissolving of a catalyst and using a resin of low pKa at the periphery thereof or between the catalyst particles thereby ensuring the ion conduction path, as well as a constituent materials thereof, a manufacturing method therefor and a fuel cell using the membrane electrode-assembly.

The present invention is to be described by way of embodiments with reference to the drawings.

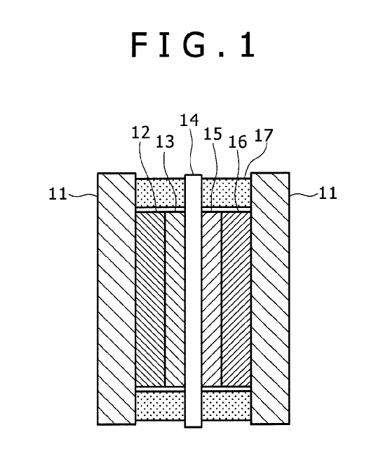

FIG. 1 shows an example of a cell configuration of a fuel cell using a membrane-electrode-assembly.

FIG. 1 shows a bipolar plate 11, an anode catalyst layer 13, an anode diffusion layer 12, a solid polymer electrolyte membrane 14 having proton conductivity, a cathode catalyst layer 15, a cathode diffusion layer 16, and a gasket 17.

The bipolar plate 11 has electron conductivity and, as a material, a dense graphite plate, a carbon plate resin-molded from a carbon material such as graphite or carbon black, a metal such as stainless steel or titanium, or the metal described above coated by a conductive paint of excellent corrosion resistance and heat resistance or noble metal plating.

The anode catalyst layer 13, the cathode catalyst layer 15, and the solid polymer electrolyte membrane 14 integrated together are referred to as a membrane-electrode-assembly. In this case, the catalyst layer and the diffusion layer are sometimes integrated.

As the catalyst used for the anode and the cathode, those having a structure where metal particles that promote fuel oxidizing reaction and oxygen reducing reaction are supported on an electron conductor of a high specific surface area are used. As the electron conductor, carbon black is used generally.

FIG. 2 shows a schematic view of a catalyst using carbon black as a support as a catalyst of this embodiment. The catalyst has a structure in which catalyst metal particles 22 are supported on carbon black.

Carbon black has a form of a catalyst particle structure 23 in which primary carbon particles 21 of 20 to 40 nm are gathered in a bead-like shape. A pore formed in the catalyst particle structure 23 is referred to as a primary pore 24, which has a size about equal with that of the primary carbon particle. Specifically, the particle diameter is 40 nm or less and it is known that most of the catalyst metal particles are present within the primary pores. A pore of a size in a range from 40 nm to 1000 nm is present between each of the catalyst particle structures 23, which is referred to as a secondary pore 25.

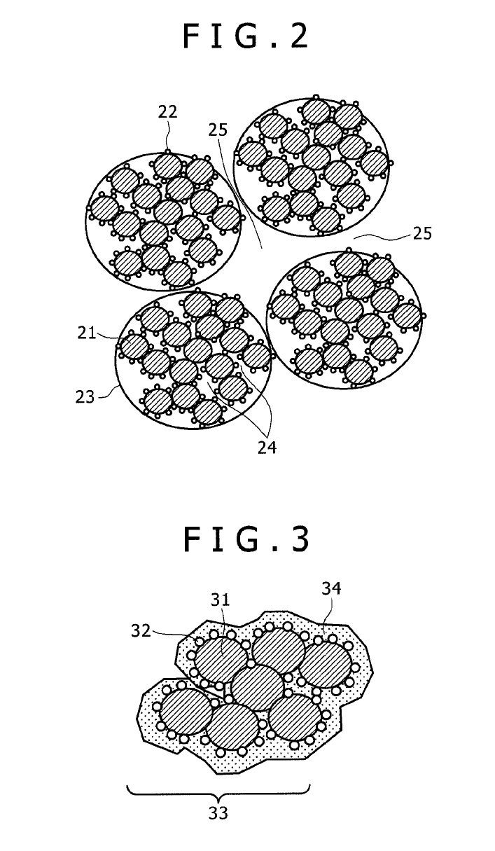

This embodiment concerns an electrode catalyst layer formed by mixing the catalyst-supporting carbon in FIG. 2 and the solid polymer electrolyte (hereinafter referred to as an electrode electrolyte) having proton conductivity. This embodiment is to be described with reference to FIG. 3 to FIG. 6.

FIG. 3 shows a schematic view of a catalyst particle agglomerate in an existent electrode catalyst layer. This is obtained by coating and drying a mixture of a catalyst supporting carbon and a liquid containing a solid polymer electrolyte used for a binder. The solid polymer electrolyte dissolved or dispersed in a solvent, together with the solvent, covers the surface of the carbon structure. When a proton exchange resin having sulfonate groups of a low acid dissociation constant as the solid polymer electrolyte 34, the atmosphere at the periphery of the catalyst metal particles 31 becomes acidic, tending to leach the catalyst metal into the solid polymer electrolyte. Further, use of anion-exchange resin of a low acid dissociation constant, for example, those having phosphate groups or carboxylic groups as the solid polymer electrolyte 34 is not desirable, since the proton conductivity in the catalyst electrode layer is increased although the solubility of the catalyst metal particle 31 can be suppressed. Further, use of an anion-exchange resin having quaternary amine groups or the like as the solid polymer electrolyte 34 is not desirable, since carbonate ions are present in the membrane to lower the ion conductivity when the resin absorbs carbon dioxide in air and, as a result, the resistance in the catalyst electrode layer is increased although the solubility can be decreased further.

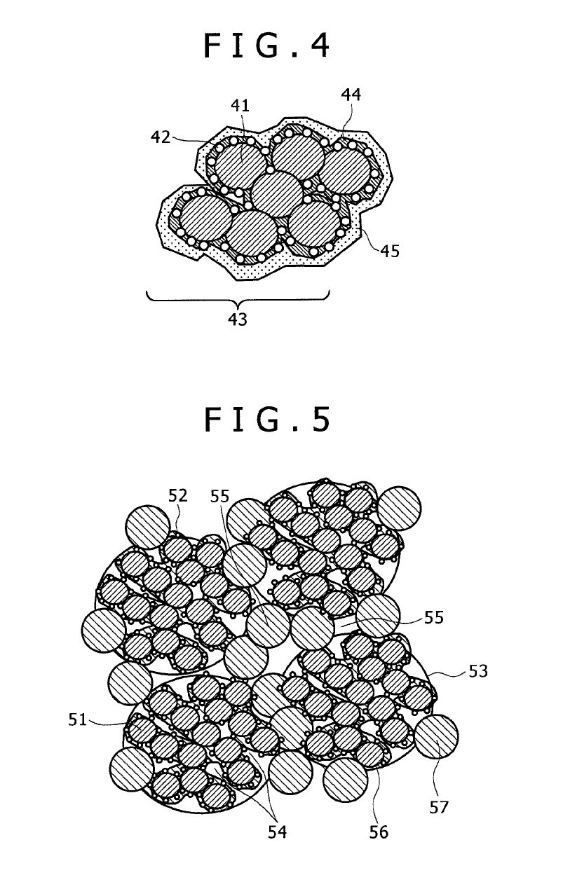

FIG. 4 to FIG. 6 show schematic views for various configurations of this embodiment.

In FIG. 4, two types of solid polymer electrolytes are present and they are referred to as a first solid polymer electrolyte 44 and a second solid polymer electrolyte 45. The first solid polymer electrolyte covers the surface of the catalyst particles, and the second solid polymer electrolyte covers the periphery thereof. When a material at high pKa is used for the first solid polymer electrolyte, since the acid strength at the periphery of the metal catalyst is lowered, solution of the metal is suppressed. Since protons or OH⁻ ions generated or consumed at the surface of the catalyst once pass through the first solid polymer electrolyte and then they are conducted through the second polymer electrolyte in the direction of the thickness of the electrolyte, ion conduction over the entire electrode strongly depends on the ion conductivity of the second solid polymer electrolyte. When a material of a low pKa is used for the second solid polymer electrolyte, the ion resistance of the entire electrode can also be kept low. As a result, oxidation resistance of the metal and the ion resistance of the entire electrode can be made compatible by the configuration as shown in FIG. 4.

The catalyst used for the anode and the cathode of this embodiment may be any metal that promotes the oxidizing reaction of a fuel and a reducing reaction of oxygen and includes, for example, platinum, gold, silver, palladium, iridium, rhodium, ruthenium, iron, cobalt, nickel, chromium, tungsten, manganese, vanadium, titanium, or alloys thereof. With a viewpoint of the resource reserve and the cost of the material, fuel cells suitable to popularization can be obtained by using other materials than platinum. Particularly, palladium, nickel, iron, cobalt, tungsten, etc. are preferred. When other materials than platinum are used, there may be a concern of metal dissolution into a solid polymer electrolyte. However, the resistance to dissolving to dissolving can be improved by using the electrode catalyst layer of the configuration shown in FIG. 4.

In FIG. 4, also in a case of using platinum, a desired membrane-electrode-assembly can be obtained since the resistance to dissolving is increased. In a case of using a platinum type catalyst, a PtRu alloy catalyst is used often for the anode and a Pt catalyst is used often for the cathode. They are supported on carbon black. The particle diameter of the metal as the catalyst is usually from 20 to 30 nm.

The catalyst metal of this embodiment is preferably supported on a carbon material of large specific surface area. When the catalyst is finely particulated, activity per unit weight increases as the specific surface area increases. The catalyst is not agglomerated and can be maintained as fine particles by supporting the catalyst metal on the carbon black. The specific surface area of the carbon black to be used is preferably selected within a range from 10 to 1000 m²/g. When the specific surface are is excessively small, hardly any substantial effect obtained by the addition of carbon black can be obtained. On the other hand, if the specific surface area is excessively large, since many pores are formed on the surface of the carbon black, catalyst particles intrude into the pores and the catalyst particles intruding into the pores less contribute to the reaction during cell operation. For example, carbon blacks such as ketjen black, furnace black, channel black, and acetylene black, fibrous carbon such as carbon nanotubes, or activated carbon, graphite carbon, etc. can be used and they can be used alone or in admixture.

Among them, use of ketjen black having a high specific surface area is desirable for increasing the activity of the catalyst electrolyte layer.

The solid polymer electrolyte used for the first solid polymer electrolyte 44 in FIG. 4 is preferably a material showing the effect of suppressing the solubility of the catalyst metal. The material includes, specifically, phosphate groups, carboxylic groups, etc. among polar groups showing proton conductivity. Further, the material also includes a polymer having anion-exchange groups such as quaternary amine groups. With the viewpoint of the resistance to dissolving of the metal, the anion-exchange resin is particularly preferred.

As the solid polymer electrolyte used for the second solid polymer electrolyte 45 shown in FIG. 4, a material of high ion conductivity is preferred. Use of the solid polymer electrolyte having sulfate groups among the polar groups showing the ion conductivity is preferred since this can decrease the proton conduction resistance in the catalyst electrode layer without undergoing the effect of carbon dioxide in atmospheric air.

Further, as the solid polymer electrolyte used for the electrolyte membrane put between the electrodes of the configuration shown in FIG. 4 (14 in FIG. 1), use of an acidic hydrogen ion conduction material is preferred since a stable fuel cell can be attained without undergoing the effect of gaseous carbon dioxide in atmospheric air. An example of them includes perfluoroalkyl sulfonate electrolytes and hydrocarbon electrolytes having polar groups showing proton conductivity. Particularly, use of hydrocarbon type electrolyte having an aromatic ring is preferred since this is excellent in the bondability between the polymers due to the effect of the interaction by π electrons of an aromatic ring. The polar group showing the proton conductivity includes sulfonate groups, phosphate groups, carboxylic groups, etc., and the sulfonate groups are particularly preferred with a viewpoint of the proton conductivity.

Use of the second solid polymer electrolyte in FIG. 4 and the electrolyte membrane having an identical chemical structure is preferred since not only the junction between the electrode and the solid polymer is improved but also proton conduction is effected smoothly between the second solid polymer and the electrolyte membrane to keep the resistance of the entire membrane-electrode-assembly low. Whether the chemical structures is identical or not can be confirmed by extracting the solid polymer electrolytes respectively from the electrode and the electrolyte membrane and comparing the molecular structures of them by using a nuclear magnetic resonance (NMR) method.

The hydrocarbon type electrolyte used for the solid polymer electrolyte includes, for example, sulfonated engineering plastic type electrolytes such as sulfonated polyether ether ketone, sulfonated polyether sulfone, sulfonated acrylonitrile/butadiene/styrene, sulfonated polysulfide, and sulfonated polyphenylene, and sulfoalkylated engineering plastic type electrolyte such as sulfoalkylated polyether ether ketone, sulfoalkylated polyether sulfone, sulfoalkylated polyether ether sulfone, sulfoalkylated polysulfone, sulfoalkylated polysulfide, sulfoalkylated polyphenylene, and sulfoalkylated polyether ether sulfone. Further, such engineering plastics that are modified with phosphoalkyl groups or modified with carboxylic groups can be used.

As the polymer having the phosphonate groups, those in which phosphonic acid is coordinated to the side chain of the aliphatic hydrocarbon can be used.

As the polymer using the carboxyl groups, those in which carboxylic acid is coordinated to the side chain of the aliphatic hydrocarbon, carboxymethyl cellulose, etc. can be used.

It may suffice that the anion-exchange resin used for the first solid polymer electrolyte has anion conducting functional groups such as CO₃²⁻ and OH⁻. For example, the anionic exchange resin includes the engineering plastics described above which are modified with trimethyl amine or trimethyl phosphine.

The pKa of the electrolyte polymer can be calculated and estimated by a plurality of methods. For example, the pKa can be determined by acid-base titration of the polymer per se and, further, it can be forecast by a molecular orbital calculation in view of the structural formula of the polymer. Further, in the most convenient method, the pKa can be estimated as pKa of the functional group itself that modifies the polymer. For example, the functional group of the perfluoroalkyl sulfonic acid includes trifluoromethane sulfonic acid, and its pKa at 25° C. is −3. The pKa for other functional groups used for the proton exchange resin is, for example, −2 for the methane sulfonic acid, 2 for phosphonate group, and 4.8 for carboxylic group. The acid dissociation constant of the functional group showing anion-exchange capacity is, for example, 11 for trimethyl amine, and 27 for aniline.

Means for manufacturing this embodiment is to be described below.

Means for covering the catalyst with the first solid polymer electrolyte includes mixing catalyst particles and a solution in which the first solid polymer electrolyte is dissolved to obtain a paste, then drying and powdering the paste. The powdering method includes a method of drying a solvent in a paste using an evaporator, a method of spraying the paste by a spray dryer or the like to dry the solvent in air, or a method of spreading and drying the paste on a substrate, scraping off the same, and then crushing the same.

For enhancing the stability of the first solid polymer electrolyte, the first solid polymer electrolyte can be crosslinked. The crosslinking method is not particularly restricted but may be a general method of crosslinking the solid polymer. An example of cross linking an aromatic-containing solid polymer electrolyte includes dissolving a phenolic crosslinker such as 4,4′-dihydroxy-3,3′-5,5′-(tetramethoxymethyl)biphenyl thereby an aromatic-containing solid polymer, applying a heat treatment, and forming a crosslinked structure between aromatic rings of different solid polymer electrolytes.

The method of providing the second solid polymer electrolyte to the catalyst particles covered with the first polymer electrolyte includes dispersing the catalyst particles covered with the first solid polymer electrolyte into a solvent under the condition in which the first solid polymer is not dissolved, adding the second solid polymer electrolyte thereto to obtain a paste, and then drying the paste.

Alternatively, the second solid polymer electrolyte may be provided by a method of coating and drying a paste containing the first solid polymer and the catalyst particles to form an electrode catalyst layer, coating thereover a solution product of the second solid polymer electrolyte and causing the second polymer electrolyte to intrude into the pores of the electrode catalyst layer.

The configuration shown in FIG. 5 is identical with that shown in FIG. 4 in that two types of solid polymer electrolytes are present and a first solid polymer electrolyte 56 covers the surface of catalyst particles. On the other hand, a second solid polymer electrolyte 57 is present in a particulate form among a plurality of catalyst particle structures 53 each including the catalyst particles. Also in this case, since the ions in the catalyst electrode layer pass by way of the first solid polymer membrane and through the second solid polymer, the effect identical with that shown in FIG. 4 can be obtained.

The particle size of a particle mass in FIG. 5 is preferably 40 nm or more with a viewpoint of material diffusibility. This means that the particle size is larger than the primary pore in the catalyst particle structure and many solid second polymers are present in the secondary pores. This configuration is preferred since spaces tend to be formed in the primary pores and the material diffusibility in the catalyst electrode layer is improved. Further, the size of the particle mass is preferably 40 nm or more and 1000 nm or less and, more preferably, 40 nm or more and 500 nm or less in order that the particle mass gathers in the secondary pores to form a good proton conduction path. The particle size of the particle mass has a distribution in an actual catalyst electrode layer. When a geometric mean is measured on a plurality of electrolyte masses for the length in the direction of the minor axis and the major axis and a histogram of the mean geometry size is prepared, it is preferred that the particle size at the highest frequency is present within the range described above.

The method of introducing the second solid polymer electrolyte as the particulate mass into the electrode includes finely milling an electrolyte powder dried after synthesis by using a ball mill, extracting only the particles of a desired size using a sieve and then mixing the particles with the catalyst supported on a support.

An alternative method includes adding a poor solvent to a varnish in which an electrolyte is dissolved in a good solvent, precipitating the electrolyte in a particulate form in the varnish, extracting particles of a desired size by centrifugation or filtration, using them. The solvent used as the good solvent or the poor solvent are not particularly restricted so long as the solvent does not poison the catalyst after cleaning. For example, the solvent includes, in addition to water, for example, alkylene glycol monoalkyl ethers, such as ethylene glycol monomethyl ether, ethylene glycol monoethyl ether, propylene glycol monomethyl ether, and propylene glycol monomethyl ether, alcohols such as n-propanol, iso-propanol, and t-butanol, and highly polar solvents such as 1-methyl-2-pyrrolidone. Two or more of them may also be used in admixture. The type of the good solvent and the poor solvent is different depending on the electrolyte material.

Alternatively, a solution containing a metal cation is dropped to a varnish in which a second solid electrolyte is dissolved in a good solvent, the electrolyte is precipitated in a particulate form in a varnish by a salting out effect and using the electrolyte mass. The cation is not particularly restricted so long as the cation can conduct ion exchange with the proton upon cleaning by an acidic aqueous solution.

Further, as the particulate solid polymer electrolyte in FIG. 5, the hydrocarbon type electrolyte subjected to crosslinking reaction to improve the intramolecular bonding, or polystyrene beads to which sulfonate groups are introduced, etc. can be used.

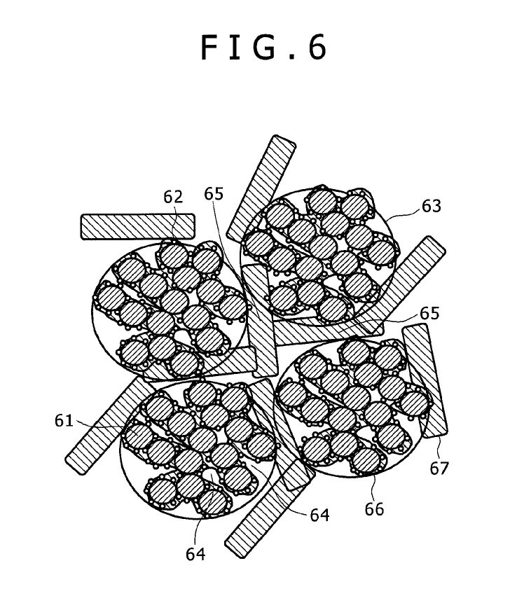

FIG. 6 shows a structure of using a second solid polymer electrolyte 67 as an acicular mass. Since the electrolyte is the acicular mass, filling of the electrolyte into the primary pores in the catalyst electrode layer can be suppressed. Further, since the acicular mass prevents agglomeration between carbon (particles) to each other, a large (space) pore volume in the catalyst electrode layer can be kept to provide excellent material diffusibility and, as a result, the same effect as that in FIG. 5 can be expected. Further, the electrode electrolyte in the acicular mass increases the frequency of contact between the mass to each other and proton conduction network can be formed at a high level.

In the electrode catalyst layers shown in FIG. 5 and FIG. 6, the solid polymer electrolyte described above can be used for the first and second polymer electrolyte.

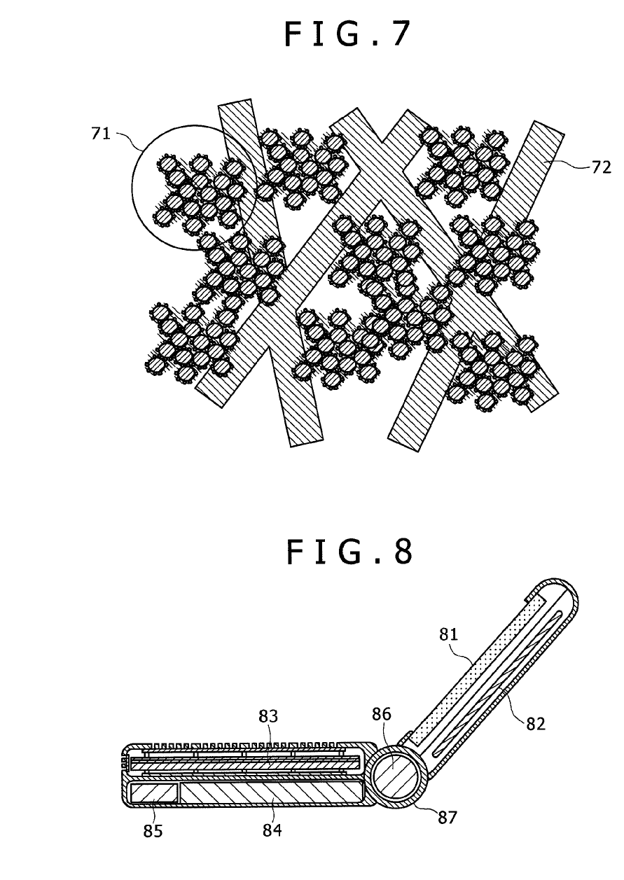

FIG. 7 shows a structure in which catalyst particles 71 covered with the first solid polymer electrolyte are filled in the voids of a fibrous network structure formed of the second solid polymer electrolyte 72. Also in this configuration, the effect identical with that in FIG. 6 can be expected. For the first solid polymer electrolyte and the second polymer electrolyte, the electrolyte identical with that described above can be used. Further, for forming the network structure including the second solid polymer, a network structure in which fibers are overlapped to each other can be obtained by discharging a solution containing the second polymer electrolyte by an electrospinning method. The electrode catalyst layer of the structure shown in FIG. 7 can be obtained by impregnating the network structure with a paste in which the first solid polymer electrolyte and the polymer particles are dissolved or dispersed, dried and then finally bonded by thermo compression.

The membrane-electrode-assembly as an embodiment of the invention can be formed by putting the solid polymer electrolyte membrane showing the proton conductivity between the catalyst electrode layers having the structure shown in FIG. 4 to FIG. 7. The electrolyte membrane includes the solid polymer electrolyte described above.

Whether the manufactured membrane-electrode-assembly has a structure as in the embodiment of the invention or not can be confirmed by observing the cross section of the obtained membrane-electrode-assembly under a scanning electron microscope (SEM). Whether a particulate or acicular electrolyte mass is present or not in the catalyst electrode layer can be judged by a cross sectional SEM image. Further, whether the observed mass is an electrolyte or not can be judged by mapping the composition by an energy dispersive X-ray spectrometer (EDX) attached to SEM.

Further, presence of two or more types of the solid polymer electrolytes as shown in FIG. 4 to FIG. 7 can be judged by observing the cross sectional slice image of the membrane-electrode-assembly by a transmission electron microscope (TEM), and analyzing the chemical composition of the relevant electrolyte by electron energy loss spectroscopy (EELS) or energy dispersive X-ray spectroscopy (EDX).

In this embodiment, the resistance to dissolving of the catalyst metal can be increased by using two or more types of solid polymer electrolytes to be contained in the cathode and the anode and lowering the acid strength of the solid polymer electrolyte in direct contact with the surface of the catalyst and the ion conduction resistance in the catalyst electrode layer can be decreased by increasing the acid strength of the solid polymer electrolyte disposed to the periphery thereof. As a result, the durability and the power generation characteristic of the membrane-electrode-assembly can be improved. Further, since inexpensive and less electrochemically noble metal can be used for the catalyst metal, an inexpensive membrane-electrode-assembly can be provided.

This embodiment is to be described more specifically but the invention is not restricted only to the example disclosed herein.

### [Synthesis of Chloromethyl Polyether Sulfone]

After nitrogen substitution for the inside of a four-necked round bottom flask of 500 mL volume connected with a stirrer, a thermometer and a calcium chloride tube, and attached with a reflux condenser, 30 g of polyether sulfone (PES) and 250 mL of carbon disulfide were charged and further 50 mL of chloromethyl methyl ether was added, a solution mixture of 1 mL of anhydrous tin chloride (IV) and 20 mL of carbon disulfide was dropped and stirred under heating at 46° C. for 120 hours. Then, the reaction solution was dropped into 1 L of methanol to precipitate a polymer. The precipitates were pulverized by a mixer and washed with methanol to obtain chloromethyl polyether sulfone.

### [Synthesis of Sulfomethyl Polyether Sulfone]

Chloromethyl polyether sulfone described above was charged in a four-necked round-bottom flask of 1000 mL volume connected with a stirrer, a thermometers and a calcium chloride tube, and attached with a reflux condenser, to which 600 mL of N-methylpyrrolidone was added. A solution of 9 g of potassium thioacetate and 50 mL of N-methyl-2-pyrrolidone (NMP) was added thereto, heated at 80° C., and they were heated and stirred for 3 hours. The reaction solution was dropped into 1 L of water to precipitate a polymer. Then, it was dried under heating to obtain acetyl thiopolyether sulfone. Acetyl thiopolyether sulfone was charged in a four-necked round-bottom flask in the same manner, acetic acid and aqueous hydrogen peroxide were further added, heated at 45° C., and heated for 4 hours. Then, 1 L of an aqueous 6N solution of sodium hydroxide was charged and stirred. The polymer was filtered and washed to obtain 20 g of sulfomethyl polyether sulfone (hereinafter referred to as a polymer A). The number average molecular weight of the polymer was 90,000 and the sulfonate group equivalent was 1.4 mmol/g.

### (Synthesis of Phosphomethyl Polyether Sulfone)

Chloromethyl polyether sulfone described above was dipped in triethylphosphonate ester and refluxed under heating for 12 hours. The reaction solution was poured into ethanol to precipitate a polymer and the precipitates were pulverized in a mixer and washed with ethanol to obtain phosphomethyl polymer ether sulfone. The acid equivalent of the phosphomethyl groups was 1.3 mmol/g. This is hereinafter referred to as a polymer B.

### (Synthesis of Quaternary Amino Group-Containing Polymer)

Chloromethyl polyether sulfone described above was dipped in trimethyl amine and refluxed under heating for 12 hours. The reaction solution was poured in ethanol to precipitate a polymer and the precipitates were pulverized by a mixer and washed with ethanol. Then, when the product in an aqueous KOH solution, washed with water and, dried, trimethyl aminated polyether sulfone was obtained. The base equivalent of the trimethyl amino group was 1.3 mmol/g. This is hereinafter referred to as a polymer C.

### [Synthesis of Pd Catalyst]

1.0 g of carbon black, 1.11 g of PdCl₂, 0.48 g of formaldehyde, and 1000 ml of pure water were mixed. While elevating the temperature and stirring them, 1 mol/L of an aqueous sodium hydroxide solution was gradually dropped to keep pH at 8 and palladium was reduced and precipitated on carbon black and supported thereon. Then, after filtering the reaction solution and washing thoroughly with pure water, they were dried at 80° C. in atmospheric air to obtain a catalyst in which Pd particles were supported on carbon black (Pd/C catalyst).

### [Preparation of Pt/C Slurry for PEFC Anode]

Carbon black supporting platinum by 70% by weight and Nafion (registered trade mark) (hereinafter referred to as Nafion (R)) were added at a weight ratio of 1:0.2 to a solvent including propanol as a main ingredient and stirred for 12 hours by a magnetic stirrer to form a Pt/C catalyst slurry. This is hereinafter referred to as a slurry A. In the examples shown below, an electrode including the Pt/C catalyst and Nafion (R) was used for the anode in all of the examples for comparison of performance at the cathode.

### [Preparation of Electrolyte Membrane]

After dissolving the polymer A in 1-methyl-2-pyrrolidone to obtain a solution at 25% by weight of concentration, it was filtered, covered on a substrate, and dried to obtain a 50 μm electrolyte membrane A.

### Preparation of Comparative Example 1

(1-1) The slurry A was coated on both surfaces of the electrolyte membrane A by using a spray coater to form an anode and a cathode. The sample after coating the electrode was bonded by thermocompression to manufacture a membrane-electrode-assembly. The hot pressing temperature was 120° C. and a pressing pressure was 80 kg/cm². After washing the pressed membrane-electrode-assembly with an aqueous solution of 1M sulfuric acid, it was subjected to a rinsing treatment with super purified water, and then dried. The electrode was sized as 30 mm×30 mm.

### Manufacture of Comparative Example 2

(2-1) A Pd/C catalyst and Nafion (R) were added at a weight ratio of 1:0.2 to a solvent including propanol as a main ingredient and stirred for 12 hours by a magnetic stirrer to form a Pd/C catalyst slurry. This is hereinafter referred to as a slurry B.
(2-2) The slurry A was coated on one surface of the electrolyte membrane A by using a spray coater to form an anode. Then, the slurry B was coated on the other surface to form a cathode. The sample after coating the electrode was bonded by thermocompression to manufacture a membrane-electrode-assembly. The hot pressing temperature was 120° C. and the pressing pressure was 80 kg/cm². After washing the pressed membrane-electrode-assembly with an aqueous solution of 1M sulfuric acid, it was subjected to a rinsing treatment with super purified water, and then dried.

### Manufacture of Comparative Example 3

(3-1) The polymer B dried at 120° C. for 2 hours was taken out by 10 g, to which 90 g of ethylene glycol monomethyl ether was dropped to obtain a solution product of the polymer B at 10% by weight of concentration.
(3-2) A Pd/C catalyst and the solution product of the polymer B prepared in (3-1) were mixed in a solvent including ethylene glycol monomethyl ether as a main ingredient. The Pd/C catalyst and the polymer B were at a dry weight ratio of 1:0.18. They were stirred for 12 hours by a magnetic stirrer to prepare a Pd/C slurry for a cathode using phosphomethyl polyether sulfone as a binder. This is hereinafter referred to as a slurry C.
(3-3) The slurry A was coated on one surface of the electrolyte membrane A by using a spray coater. Then, the slurry C was coated on the other surface to form a cathode. The sample after coating the electrodes was bonded by thermocompression using a hot press to manufacture a membrane-electrode-assembly. The hot pressing temperature was 120° C. and the pressing pressure was 80 kg/cm². After washing the pressed membrane-electrode-assembly with an aqueous solution of 1M sulfuric acid, it was subjected to a rinsing treatment with superpurified water, and then dried.

### Manufacture of Comparative Example 4

(4-1) Carboxymethyl cellulose (hereinafter referred to as polymer D) dried for 2 hours was taken out by 10 g, to which 90 g of a mixture of water and ethylene glycol monomethyl ether was dropped to obtain a solution product of the polymer D at 10% by weight of concentration.
(4-2) A Pd/C catalyst and the solution product of the polymer D prepared in (4-1) were mixed to a solvent including ethylene glycol monomethyl ether as a main ingredient. The Pd/C catalyst and the polymer D were at a dry weight ratio of 1:0.18. They were stirred for 12 hours by a magnetic stirrer to prepare a Pd/C slurry for cathode with the polymer having carboxyl groups as a binder. This is hereinafter referred to as a slurry D.
(4-3) The slurry A was coated on one surface of the electrolyte membrane A by using a spray coater to form an anode. Then, the slurry D was coated on the other surface to form a cathode. The sample after coating the electrodes was bonded by thermocompression using a hot press to manufacture a membrane-electrode-assembly. The hot pressing temperature was 120° C. and the pressing pressure was 80 kg/cm². After washing the pressed membrane-electrode-assembly with an aqueous solution of 1M sulfuric acid, it was subjected to a rinsing treatment with superpurified water and then dried.

### Manufacture of Comparative Example 5

(5-1) The polymer C dried for 2 hours was taken out by 10 g, to which 90 g of a mixture of water and ethylene glycol monomethyl ether was dropped to obtain a solution product of the polymer C at 10% by weight of concentration.
(5-2) A Pd/C catalyst and the solution product of the polymer C prepared in (5-1) were mixed in a solvent including ethylene glycol monomethyl ether as a main ingredient. The Pd/C catalyst and the polymer C were at a dry weight ratio of 1:0.18. They were stirred for 12 hours by a magnetic stirrer to prepare a Pd/C slurry for a cathode with a polymer having a trimethyl amino group as a binder. This is hereinafter referred to as a slurry E.
(5-3) The slurry A was coated on one surface of the electrolyte membrane A by using a spray coater to form an anode. After coating the slurry E on a 50 mm×50 mm PTFE sheet and drying the same, it was dipped in an aqueous solution of 0.1 M KOH and washed with water and dried to form a cathode. Further, the electrolyte membrane attached with the anode was washed with an aqueous solution of 1M sulfuric acid, subjected to a rinsing treatment with super purified water, and then dried. A cathode-coated PTFE sheet was bonded to the back of the electrolyte membrane attached with the anode and the cathode and the electrolyte membrane were joined by thermocompression bonding. The hot pressing temperature was 120° C. and the pressing pressure was 80 kg/cm². The PTFE sheet was peeled from the cathode to manufacture a membrane-electrode-assembly.

### Manufactured of Example 1

(6-1) A Pd/C catalyst, the solution product of the polymer C prepared in (5-1), and Nafion (R) were mixed in a solvent including ethylene glycol monomethyl ether as a main ingredient. The Pd/C catalyst, the polymer C, and the Nafion (R) were at a dry weight ratio of 1:0.09:0.09. They were stirred for 12 hours by a magnetic stirrer to prepare a Pd/C slurry for cathode in which the polymer having the trimethyl amino groups and the Nafion (R) are present in admixture. This is hereinafter referred to as a slurry F.
(6-2) The slurry A was coated on one surface of the electrolyte membrane A by using a spray coater to form an anode. The slurry F was coated for a size of 30 mm×30 mm on a 50 mm×50 mm PTFE sheet, dried and then dipped into an aqueous solution of 0.1M KOH, washed with water, and dried to form a cathode. Further, an electrolyte membrane attached with the anode was washed with an aqueous solution of 1M sulfuric acid, then subjected to a rinsing treatment with super purified water, and dried. The cathode and the electrolyte membrane were joined by bonding a cathode-coated PTFE sheet to the back of the electrolyte membrane attached with the anode by thermocompressing bonding. The hot pressing temperature was 120° C. and the pressing pressure was 80 kg/cm². The PTFE sheet was peeled from the cathode to manufacture a membrane-electrode-assembly.

### Manufacture of Example 2

(7-1) A Pd/C catalyst and the solution product of the polymer C prepared in (5-1) were mixed in a solvent including ethylene glycol monomethyl ether as a main ingredient. The Pd/C catalyst and the polymer C were at a dry weight ratio of 1:0.09. They were stirred for 12 hours by a magnetic stirrer to prepare a Pd/C slurry for a cathode in which the Pd/C catalyst and the polymer having trimethyl amino groups were present in admixture. This is hereinafter referred to as a slurry G.
(7-2) The slurry G obtained in (7-1) was dried while evaporating the solvent using a spray drier to obtain a powder. The powder was pulverized and sieved. Then, the product was washed with 0.1M aqueous KOH and rinsed with pure water and dried. This is referred to as a powder G. As a preliminary investigation, when the powder G was immersed in an aqueous propanol solution and stirred by a magnetic stirrer, the polymer was not leached from the powder.
(7-3) After adding the powder G obtained in (7-2) to a solvent including propanol as a main ingredient, a liquid dispersion containing Nafion (registered trademark) was added thereto and stirred. The powder G and the Nafion (R) were at a mixing ratio of 1.09:0.09 by dry weight. The product was stirred for 12 hours by a magnetic stirrer to form a Pt/C catalyst slurry. This is referred to as a slurry G2.
(7-4) The slurry A was coated on one surface of the electrode membrane A by using a spray coater to form an anode. The slurry G2 was coated on a 50 mm×50 mm PTFE sheet. After drying, it was dipped in an aqueous solution of 0.1M KOH, washed with water, and dried to form a cathode. Further, after washing the electrolyte membrane attached with the anode with an aqueous solution of 1M sulfuric acid, it was subjected to a rinsing treatment with a super-purified water and dried. The cathode and the electrode membrane were joined by bonding an anode-coated PTFE sheet coated with the cathode to the back of the electrolyte membrane and by thermocompression bonding. The hot pressing temperature was 120° C. and the pressing pressure was 80 kg/cm². The PTFE sheet was peeled from the cathode to manufacture a membrane-electrode-assembly.
(7-5) When the cathode of the membrane-electrode-assembly obtained in (7-4) was sliced by a freezing microtome and observed by STEM-EDX, presence of an F-containing resin (Nafion (R)) was confirmed at the periphery of a Pd/C agglomerate covered with an N-containing resin (polymer C).

### Manufacture of Example 3

(8-1) The slurry G obtained in (7-1) was coated on a 50 mm×50 mm PTFE sheet by using a spray coater. After drying, it was dipped in an aqueous solution of 0.1M KOH, washed with water, and dried to form a cathode.
(8-2) A diluted Nafion dispersion was coated over the cathode obtained in (8-1), impregnated into the cathode, dried, then rinsed with pure water, and dried again. In this process, the Pd/C catalyst, the polymer C, and the Nafion in the electrode were at a mixing ratio of 1:0.09:0.09 by dry weight.
(8-3) The slurry A was coated on one surface of the electrolyte membrane A by using a spray coater to form an anode. After washing the electrolyte membrane attached with the anode with an aqueous solution of 1M sulfuric acid, it was subjected to a rinsing treatment with super purified water and dried. The cathode and the electrolyte membrane were joined by bonding the cathode-coated PTFE sheet obtained in (8-2) to the back of the electrolyte membrane attached with the anode and by thermocompression bonding. The hot pressing temperature was 120° C. and the pressing pressure was 80 kg/cm². The PTFE sheet was peeled from the cathode to manufacture a membrane-electrode-assembly.
(8-4) When the cathode of the membrane-electrode-assembly obtained in (8-3) was sliced by a freezing microtome and observed by STEM-EDX, presence of an F-containing resin (Nafion (R)) was confirmed at the periphery of the Pd/C agglomerate covered with an N-containing resin (polymer C).

### Manufacture of Example 4

(9-1) A membrane-electrode-assembly was prepared in the same manner as in Example 2 except for changing the solution product of the polymer to be mixed with the Pd/C catalyst to the solution product of the polymer B in (7-1).
(9-2) When the cathode of the membrane-electrode-assembly obtained in (9-1) was sliced by a freezing microtome and observed by STEM-EDX, presence of an F-containing resin (Nafion (R)) was confirmed at the periphery of the Pd/C agglomerate covered with an N-containing resin (polymer C).

### Manufacture of Example 5

(10-1) A membrane-electrode-assembly was prepared in the same manner as in Example 2 except for changing the solution product of the polymer to be mixed with the Pd/C catalyst to the solution product of the polymer D in (7-1).
(10-1) When the cathode of the membrane-electrode-assembly obtained in (10-1) was sliced by a freezing microtome and observed by STEM-EDX, presence of an F-containing resin (Nafion (R)) was confirmed at the periphery of the Pd/C agglomerate covered with an C,O-containing resin (polymer B). Further, the cathode electrode was dissolved in DMAc (dimethyl acetoamide) to extract a dissolved solution and the dried product was subjected to infrared spectroscopy to confirm that the product contained a binder having carboxylic groups.

### Manufacturing of Example 6

(11-1) The polymer A dried at 120° C. for 2 hours was taken out by 10 g, to which 1-propanol, 2-propanol, and water mixed at a weight ratio of 80:80:20 was dropped by 90 g. A sample bottle containing the mixture was placed in a water bath attached with a supersonic wave generation device and supersonic waves were generated to dissolve the polymer A. This is referred to as a dissolved polymer solution A2.
(11-2) A membrane-electrode-assembly was obtained in the same manner as in Example 2 except for changing the second solid polymer electrolyte added to the slurry from the liquid dispersion of Nafion (R) to the dissolved polymer solution A2.
(11-3) When the cathode of the membrane-electrode-assembly obtained in (11-2) was sliced by a freezing microtome and observed by STEM-EDX, presence of an S-containing resin film (polymer A) at the periphery of the Pd/C agglomerate covered with an N-containing resin (polymer C) was confirmed. Further, the cathode electrode was dissolved in DMAc (dimethyl acetoamide) and NMR analysis was performed on the dissolved solution to confirm that the binder in the electrode contained the polymer A having the sulfonate groups and the polymer C having the trimethyl amino groups.

### Manufacture of Example 7

(12-1) When an aqueous solution of 0.2M sodium hydroxide was added to the solution product of the polymer A prepared in (11-1) (polymer solution A2) to neutralize the pH of the liquid dispersion, dispersed particles of the polymer B were formed in the liquid. This is referred to as a polymer liquid dispersion A3. When the size of the dispersed particles in the polymer liquid dispersion A3 was measured by using a dynamic light scattering measuring apparatus (ESL 8000 manufactured by OTSUKA ELECTRONICS CO., LTD.), a distribution peak was confirmed in a range of 100 nm.
(12-2) After adding the powder G obtained in (7-2) to a solvent including a propanol as a main ingredient, the polymer liquid dispersion A3 obtained in (12-1) was added. The powder G and the polymer A were at a mixing ratio of 1.09:0.09 by dry weight. They were stirred for 12 hours by a magnetic stirrer to form a Pt/C catalyst slurry. This is referred to as a slurry H.
(12-3) A membrane-electrode-assembly was obtained in the same manner as in Example 7 except for changing the slurry to be coated on the PTFE sheet from the slurry G2 to the slurry H.
(12-4) When the cathode of the membrane-electrode-assembly obtained in (11-1) was sliced by a freezing microtome and observed by STEM-EDX, the presence of an S-containing 50 nm particulate resin (polymer A) was confirmed at the periphery of the Pd/C agglomerate covered with an N-containing resin (polymer C). Further, when the cathode electrode was dissolved in DMAc (dimethylacetoamide) and NMR analysis was performed on the dissolved solution, it was confirmed that the binder in the electrode contained the polymer A having the sulfonate groups and the polymer having a trimethyl amino groups.

### Manufacture of Example 8

(13-1) The polymer A dried at 120° C. for 2 hours was taken out by 10 g, to which 90 g of DMAc was added and dissolved. This is hereinafter referred to as a polymer solution product A4.
(13-2) The polymer solution product A4 was poured in a chamber attached with a nozzle, and the polymer solution A4 was discharged from the top end of the nozzle while applying an electric field at 50 kV to form a nanofiber thin film of 30 μm thickness on a target. The diameter of the fiber was about 100 nm.
(13-3) The slurry G obtained in (7-1) was coated and impregnated to the nanofiber thin film obtained in (13-2) and dried to form a cathode.
(13-4) The slurry A was coated on one surface of an electrolyte membrane A by using a spray coater to form an anode. The electrolyte membrane attached with the anode is washed with an aqueous solution of 1M sulfuric acid, then subjected to a rinsing treatment, dried, and thermocompression bonded. The cathode and the electrolyte membrane were joined by bonding the cathode obtained in the (13-3) to the back of the electrolyte membrane attached with the anode and by thermocompression bonding. The hot pressing temperature was 120° C. and the pressing pressure was 80 kg/cm².
(13-5) When the cathode of the membrane-electrode-assembly obtained in (13-4) was sliced by a freezing microtome and observed by STEM-EDX, it was confirmed that the Pd/C agglomerate covered with an N-containing resin (polymer C) intruded and agglomerated in the nanofibers including the polymer A.

### Manufacture of Example 9

(14-1) The Pd/C catalyst and the solution product of the polymer C prepared in (5-1) were mixed to a solvent including ethylene glycol monomethyl ether as a main ingredient. Further, 4,4′-dihydroxy-3,3′,5,5′-(tetramethoxymethyl)biphenyl (TMOM) was added as a crosslinker to the polymer C. The PD/C catalyst, the polymer C, and the TMOM were at a dried weight ratio of 1:0.09:0.009. The mixture was stirred for 12 hours by a magnetic stirrer to prepare a Pd/C slurry for a cathode in which the Pd/C catalyst and the polymer having trimethyl amino groups were present in admixture. This is referred to as a slurry I.
(14-2) The slurry I obtained in (14-1) was dried to evaporate the solvent using a spray dryer device to obtain a powder product. The powder was pulverized and sieved. Then, the product was washed with aqueous 0.1 M KOH, rinsed with pure water, and then dried. This is referred to as a powder I. When the powder I was dipped in an aqueous solution of 2-propanol and stirred by a magnetic stirrer, leaching of the polymer from the powder was not confirmed. In the same manner, the powder I was not dissolved also in DMAc or N-methyl-2-pyrrolidone.
(14-3) A membrane-electrode-assembly was obtained in the same manner as in Example 2 except for changing the powder used for the preparation of the slurry from the powder G to the power I in (7-3).

### Manufacture of Example 10

The slurry A was coated on one surface of a PTFE sheet by using a spray coater, washed with water, dried, and then dipped in ethylene diamine. By the procedure, diamine was coordinated to the sulfonic acid site of Nafion (R) of the binder in the cathode after coating.

(15-2) A membrane-electrode-assembly was prepared in the same manner as in Example 3 except for changing in (8-3) the cathode to be joined with the electrolyte membrane A attached with the anode to the cathode obtained in (15-1).
(15-3) When the cathode of the membrane-electrode-assembly obtained in (15-2) was sliced by a freezing microtome and observed by STEM-EDX, it was observed that a Pd/C agglomerate coated with an N- or F-containing resin (ethylene diamine-modified Nafion (R)) was covered with an F-containing resin (Nafion) membrane.

### [Manufacture of Fuel Cell]

Fuel cells were manufactured by attaching carbon paper on both surfaces of each of membrane-electrode-assemblies obtained in Comparative Examples 1 to 5 and Examples 1 to 10, bonding a seal gasket to the periphery of the electrode and putting them between bipolar plates including carbon.

### [Aging of Fuel Cell]

After supplying a nitrogen gas at 100% relative humidity on the side of the anode and the cathode for 24 hours or more, moistened hydrogen was supplied to the anode and moistened oxygen was supplied to the cathode and an aging treatment was performed while taking out a current by using an electronic loading device. After the cell voltage was stabilized at a current density of 0.25 A/cm², aging was completed.

### [Resistance to Dissolving Test on Catalyst Metal]

A hydrogen gas at 100% relative humidity was supplied to the anode and a nitrogen at 100% relative humidity was supplied to the cathode and, after OCV was lowered to 0.5V or lower, a linear sweep voltammetry test was performed on the cathode with the anode as a reference. The potential given on the cathode was set to 0 to 1.2V with the anode as a reference. Since a metal is dissolved and an oxidation current flows at a high potential, the current was measured and defined as an index of resistance to dissolving of the metal catalyst used for the cathode. The current is hereinafter referred to as a dissolving current.

### [Ion Conduction Resistance of Cathode]

In a state of supplying a hydrogen gas at 100% relative humidity to the anode and supplying a nitrogen at 100% relative humidity to the cathode, an AC impedance measurement was performed to measure ion conduction in the membrane-electrode-assembly. For the obtained Nyquist plots, a fitting treatment was executed by using an equivalent circuit of a transmission line model considering the ion conduction resistance in the electrode to obtain an ion conduction resistance in the electrode. Since the thickness of the cathode was different in each of the examples, the ion conduction resistance is standardized to a value per 10 μm (thickness) of the electrode in each of the cases.

Table 1 collectively shows ratings of each of the comparative examples and each of the examples. Further, Table 2 shows the dissolving current of the catalyst and the ion conduction resistance in the electrode in each of the comparative examples and each of the examples. The dissolving current is a current at a cathode potential of 1.2V and the current value standardized in accordance with the previously measured surface area of the metal catalyst was used.

TABLE 1

| | Cathode | | | Electrolyte |
|---|---|---|---|---|
| Sample | catalyst | First binder | Second binder | membrane |
| Comp. Example 1 | Pt/C | Nafion (R) | — | Electrolyte |
| | | | | membrane A |
| Comp. Example 2 | Pd/C | Nafion (R) | — | Electrolyte |
| | | | | membrane A |
| Comp. Example 3 | Pd/C | Polymer B | — | Electrolyte |
| | | | | membrane A |
| Comp. Example 4 | Pd/C | Polymer D | — | Electrolyte |
| | | | | membrane A |
| Comp. Example 5 | Pd/C | Polymer C | — | Electrolyte |
| | | | | membrane A |
| Example 1 | Pd/C | Polymer C | Nafion (R) | Electrolyte |
| | | | | membrane A |
| Example 2 | Pd/C | Polymer C | Nafion (R) | Electrolyte |
| | | | | membrane A |
| Example 3 | Pd/C | Polymer C | Nafion (R | Electrolyte |
| | | | | membrane A |
| Example 4 | Pd/C | Polymer B | Nafion (R) | Electrolyte |
| | | | | membrane A |
| Example 5 | Pd/C | Polymer D | Nafion (R) | Electrolyte |
| | | | | membrane A |
| Example 6 | Pd/C | Polymer C | Polymer A | Electrolyte |
| | | | | membrane A |
| Example 7 | Pd/C | Polymer C | Polymer A, | Electrolyte |
| | | | particulate | membrane A |
| Example 8 | Pd/C | Polymer C | Polymer A, | Electrolyte |
| | | | fibrous | membrane A |
| Example 9 | Pd/C | Polymer C | Polymer A | Electrolyte |
| | | | (crosslinked) | membrane A |
| Example 10 | Pd/C | Amino | Nafion (R) | Electrolyte |
| | | modified | | membrane A |
| | | Nafion | | |

TABLE 2

| | Metal dissolving | Electrode ion resistance |
|---|---|---|
| | current per catalyst | (per 10 μm thickness of |
| | surface area | electrode) |
| Sample | [A/cm²-catalyst] | [mΩcm²] |
| Comp. Example 1 | 2.0 × 10⁻⁵ | 50 |
| Comp. Example 2 | 5.0 × 10⁻⁵ | 55 |
| Comp. Example 3 | 0.9 × 10⁻⁵ | 100 |
| Comp. Example 4 | 0.8 × 10⁻⁵ | 520 |
| Comp. Example 5 | 0.3 × 10⁻⁵ | 300 |
| Example 1 | 1.5 × 10⁻⁵ | 150 |
| Example 2 | 0.8 × 10⁻⁵ | 53 |
| Example 3 | 0.5 × 10⁻⁵ | 55 |
| Example 4 | 1.0 × 10⁻⁵ | 60 |
| Example 5 | 0.9 × 10⁻⁵ | 61 |
| Example 6 | 0.4 × 10⁻⁵ | 45 |
| Example 7 | 0.4 × 10⁻⁵ | 42 |
| Example 8 | 0.3 × 10⁻⁵ | 40 |
| Example 9 | 0.5 × 10⁻⁵ | 50 |
| Example 10 | 0.4 × 10⁻⁵ | 60 |

### [Consideration]

Compared with the cathode of Comparative Example 1 using Pt/C for the catalyst and Nafion (R) for the binder, the dissolving current increases in Comparative Example 2 using Pd/C for the catalyst and it can be seen that the resistance to dissolving of the metal of Pd/C is poor compared with that of Pt/C. Then, the dissolving current can be decreased by using polymers having phosphonate groups, carboxylic groups, or trimethyl amino groups showing acid dissociation constant higher than that of fluoromethane sulfonic acid as the functional groups of the binder covering the Pd/C (polymer B, polymer D, polymer C), (Comparative Examples 3 to 5). However, such Comparative examples involve a problem that the electrode ion resistance becomes higher due to high pKa of the function groups of the binder.

On the contrary, in Example 1, the metal dissolving current can be decreased compared with that in Comparative Example 1 by mixing a polymer C of lower pKa and Nafion. Further, in Example 2, decrease in the dissolving current and decrease in the electrode resistance are made compatible by separating the function of two binders, that is, by covering the surface of the catalyst with the polymer C having trimethyl amino groups as a first binder and surrounding the periphery thereof with Nafion (R) to form an ion conduction path. Further, the same effect was also confirmed in Example 3 in which a Nafion solution was impregnated into the catalyst electrode layer covered with the first binder including the polymer C. The same effect can be confirmed also when the functional group of the first solid electrolyte is changed from the trimethyl amino group to the phosphonate groups or the carboxylic group (Examples 4, 5).

In Example 6, the second solid polymer electrolyte is changed from Nafion (R) of Example 2 to the polymer A thereby enabling to decrease the electrode ion resistance. It is considered that the ion resistance also includes the resistance relative to the interface of the electrolyte, and it can be construed that the ion resistance at the interface was decreased by constituting the second solid polymer electrolyte with the polymer A of an identical species with that of the electrolyte membrane.

In Examples 7, 8, the precipitated form of the second solid polymeric electrolyte in Example 6 was changed from the state of membrane (Example 6) to a particulate shape (Example 7) and a fibrous shape (Example 8), in which the electrode ion resistance can be decreased while maintaining a dissolving current at a comparable level.

In Example 9, the first solid polymeric electrolyte of Example 2 was crosslinked which is intended to improve the stability of the binder covering the catalyst. Accordingly, the resistance to dissolving of the metal can be kept stable for a long time.

In Example 10, ethylene diamine-coordinated Nafion (R) was used as the first solid polymer electrolyte. Since the acid dissociation constant of the amino group is high, the dissolving current of the metal catalyst can be lowered.

In Example 1 to Example 10, the electrode according to the invention is used only for the cathode. However when this is used also for the anode, improvement in the corrosion resistance of the catalyst metal or the decrease in the ion conduction resistance in the electrode can be expected.

While Pd/C is used as the catalyst in Example 1 to Example 10, this may be changed to other metal catalyst, and the same effect can be obtained also by using a catalyst including nickel, cobalt, iron, tungsten, etc.

FIG. 8 shows an Example of mounting a membrane-electrode-assembly as one of the embodiments of the invention to a mobile information terminal as an example of a fuel battery generation system.

The mobile information terminal has a folding type structure in which two portions are connected by a hinge 87 that also serves as a holder for a fuel cartridge 86.

In one of the portions, a display device 81 integrated with a touch panel input device and an antenna 82 is incorporated.

The other portion includes a fuel battery 83, a main board 84 in which electronic equipment and electronic circuits such as a processor, volatile and nonvolatile memories, a power control section, fuel battery and secondary battery hybrid controls, a fuel monitor, etc. are mounted and a lithium ion secondary battery 85.

Since the mobile information terminal obtained as described above has high power fuel battery 83, this can be used as equipment reduced in the size and weight.

Further, by using an alcohol fuel such as methanol or ethanol as the fuel used herein, the information terminal can be used as equipment of high fuel handlability.

Further, by using a nitrogen-containing fuel such as ammonia or hydrazine, carbon dioxide is no longer contained in an exhaust gas generated from the equipment and this can be used as desirable equipment in view of the environmental load.

What is claimed is:

1. A membrane-electrode-assembly for a fuel cell comprising: an anode including a catalyst electrode layer containing catalyst particles and a solid polymer electrolyte having ion exchange groups, and a cathode including a catalyst electrode layer containing catalyst particles and a solid polymer electrolyte having ion exchange groups are provided with a solid polymer electrolyte membrane between them,
wherein a catalyst electrode layer of at least one of the anode and the cathode contains a first solid polymer electrolyte having ion exchange groups and a second solid polymer electrolyte having ion exchange groups different from those of the first solid polymer electrolyte, and acid dissociation constants (pKa) of the ion exchange groups of the solid polymer electrolytes are different.

2. The membrane-electrode-assembly according to claim 1,
wherein a surface of the catalyst particles is covered with the first solid polymer electrolyte,
a periphery of the first solid polymer electrolyte is covered with the second solid polymer electrolyte, and
the pKa of the first solid polymer electrolyte is higher than the pKa of the second solid polymer electrolyte.

3. The membrane-electrode-assembly according to claim 1,
wherein the second solid polymer electrolyte has a particulate or acicular shape,
the second solid polymer electrolyte is disposed to the periphery of the catalyst particles covered with the first solid polymer electrolyte, and
the pKa of the solid polymer electrolyte is higher than the pKa of the second solid polymer electrolyte.

4. The membrane-electrode-assembly according to claim 3,
wherein grain size distribution of the second solid polymer electrolyte has one or more peaks, and
L1>40 nm,
where L1 represents a particle diameter providing the maximum peak.

5. The membrane-electrode-assembly according to claim 1,
wherein catalyst particles covered with the first solid polymer electrolyte are disposed in voids of a three-dimensional network structure including a fibrous second solid polymer, and
the pKa of the first solid polymer electrolyte is higher than the pKa of the second solid polymer electrolyte.

6. The membrane-electrode-assembly according to claim 5,
wherein the network structure including the second solid polymer electrolyte is prepared by using an electrospinning method.

7. The membrane-electrode-assembly according to claim 1,
wherein the catalyst particles each includes metal particles showing a catalytic effect and an electron conductor on which the particles are supported, and
a relation: pKa>pH is established between
the pKa of the first solid polymer electrolyte and
the pH of an aqueous solution where solubility of the metal particle is 10⁻⁶ mol/L.

8. The membrane-electrode-assembly according to claim 1,
wherein the ion exchange groups contained in the first solid polymer is a phosphate group or a carboxylic group.

9. The membrane-electrode-assembly according to claim 1,
wherein the first solid polymer electrolyte has an anion-exchange capacity.

10. The membrane-electrode-assembly according to claim 8,
wherein the ion exchange group contained in the first solid polymer electrolyte contains one of quaternary amine groups and quaternary phosphine groups.

11. The membrane-electrode-assembly according to claim 1,
wherein a polyvalent basic material is coordinated to the ion exchange groups of a cation exchange resin of the first solid polymer electrolyte.

12. The membrane-electrode-assembly according to claim 1,
wherein the ion exchange group contained in the second solid polymer electrolyte is a sulfonate group.

13. The membrane-electrode-assembly according to claim 1,
wherein a chemical formula of the second solid polymer electrolyte and that of the electrolyte membrane are identical.

14. The membrane-electrode-assembly according to claim 1,
wherein at least one of the first and the second solid polymer electrolytes in the catalyst electrode layer and the polymer electrolyte membrane between the electrodes includes an aromatic hydrocarbon type electrolyte having sulfonic groups.

15. The membrane-electrode-assembly according to claim 1,
wherein metal material showing catalytic effect contains at least one of palladium, nickel, iron, cobalt, and tungsten.

16. A fuel cell in which the membrane-electrode-assembly according to claim 1 is used for a power generation section.

17. The fuel cell according to claim 16, wherein an alcohol is used as a fuel.

18. The fuel cell according to claim 16, wherein one of hydrazine and ammonia is used as a fuel.

19. A fuel cell power generation system having the fuel cell according to claim 16 mounted thereon.

20. A method of manufacturing a membrane-electrode-assembly for a fuel cell in which an anode including a catalyst electrode layer containing catalyst particles and a solid polymer electrolyte having ion exchange groups, and a cathode including a catalyst electrode layer containing catalyst particles and a solid polymer electrolyte having ion exchange groups are formed with a solid polymer electrolyte membrane between them, the method comprising the steps of:
mixing the catalyst particles and a first solid polymer electrolyte in a solvent to prepare a first paste,
drying the paste and pulverizing the same thereby covering a surface of the catalyst particles with the first solid polymer electrolyte,
mixing the catalyst particles covered with the first solid polymer electrolyte and a second solid polymer electrolyte in a solvent to prepare a second paste and
drying the second paste to form an electrode, in which
the acid dissociation constant (pKa) of the ion exchange group is different between the first solid polymer electrolyte and the second solid polymer electrolyte.

21. The method of manufacturing a membrane-electrode-assembly according to claim 20, wherein
the method includes adding a crosslinker to the first paste, drying the same and then promoting the crosslinking reaction of the first solid polymer electrolyte by a heat treatment.

22. A method of manufacturing a membrane-electrode-assembly for a fuel cell in which an anode including a catalyst electrode layer containing catalyst particles and a solid polymer electrolyte having ion exchange groups, and a cathode including a catalyst electrode layer containing catalyst particles and a solid polymer electrolyte having ion exchange groups are formed while providing a solid polymer electrolyte membrane between them, the method comprising the steps of:
precipitating a solution product of a second solid polymer electrolyte by using an electrospinning method thereby obtaining a porous thin film including a second solid polymer membrane;
mixing the catalyst particles and a first solid polymer electrolyte in a solvent thereby preparing a first paste;
impregnating the first paste into the porous thin film and drying the same; and
thermocompression bonding them,
wherein the acid dissociation constant (pKa) of ion exchange groups is different between the first solid polymer electrolyte and the second solid polymer electrolyte.
